(19) United States
(12) Patent Application Publication
(10) Pub. No.: US 2003/0197057 A1
(43) Pub. Date: Oct. 23, 2003

(54) Monitor and control port for circuit cards

(75) Inventors: Joseph Menashe, Bat-Yam (IL); Van Nadav, Tel Aviv (IL)

Correspondence Address: Fogg Slifer Polglaze Leffert & Jay, P.A., P.O. Box 581009, Minneapolis, MN, 55458-1009, US

(73) Assignee: ADC Telecommunications Israel Ltd.

(21) Appl. No.: 10/127,920

(22) Filed: Apr. 23, 2002

(51) Int. Cl. G06K 5/00

(52) U.S. Cl. 235/380

(57) ABSTRACT

An electronic circuit card having a central processing unit and a port electrically connected to the central processing unit is provided. The port is electrically connectable to a monitor and control system via a backplane of a housing for containing the electronic circuit card and a panel located externally of the housing. The monitor and control system is located externally of the housing and the panel. The port is adapted to convey signals between the central processing unit and the monitor and control system for at least one of monitoring and altering the operation of one or more software programs of the central processing unit.

### TECHNICAL FIELD

The present invention relates generally to the field of electronic circuit cards and, in particular, to monitor and control ports for electronic circuit cards.

### BACKGROUND

Many electronic modules, such as electronic modules of telecommunications systems, include a number of electronic circuit cards, such as line cards, e.g., digital subscriber line (DSL) cards, common telephony module (CTM) cards, or the like. Many line cards have a central processing unit (CPU) for controlling the cards and/or providing functionality to the cards via software programs running on the CPU. Some electronic modules also include one or more main (or management) electronic circuit cards electrically connected to the CPU of each of the line cards.

The main cards usually have a port that is connectable to a computer or the like for configuring and/or debugging the line cards. However, software programs running on the CPUs of the line cards cannot be monitored or altered via the main card using a computer or the like. Therefore, if problems occur with a line card due to problems with the software programs, the line card is removed from the module and replaced with another line card. However, this disrupts service to customers.

One way to monitor and/or alter operation of the software of a CPU of a line card is by connecting a monitor and control system, such as a personal computer or the like, to a maintenance (or craft) port, such as an RS-232 port, located on the CPU. One problem with this is that the maintenance port is difficult to access without removing an adjacent line card, which results in service interruptions. Moreover, the maintenance port typically increases the size of the electronic circuit card. This reduces the number of cards that can fit into the electronic module.

For the reasons stated above, and for other reasons stated below that will become apparent to those skilled in the art upon reading and understanding the present specification, there is a need in the art for alternatives to connecting a monitor and control system directly to ports located on CPUs of electronic circuit cards to monitor and/or alter operation of the software of the CPU.

### SUMMARY

The above-mentioned problems with connecting a monitor and control system directly to ports located on CPUs of electronic circuit cards to monitor and/or alter operation of the software of the CPU and other problems are addressed by embodiments of the present invention and will be understood by reading and studying the following specification.

In one embodiment, an electronic circuit card having a central processing unit and a port electrically connected to the central processing unit is provided. The port is electrically connectable to a monitor and control system via a backplane of a housing for containing the electronic circuit card and a panel located externally of the housing. The monitor and control system is located externally of the housing and the panel. The port is adapted to convey signals between the central processing unit and the monitor and control system for at least one of monitoring and altering the operation of one or more software programs of the central processing unit.

In another embodiment, an electronic module is provided. The electronic module has a backplane having a first port and an electronic circuit card having a second port electrically connected to the first port. The second port is also electrically connected to a central processing unit of the electronic circuit card. Moreover, the first port is electrically connectable to a panel located externally to the electronic module so as to electrically connect the central processing unit to a monitor and control system located externally to the panel and the electronic module for at least one of monitoring and altering the operation of one or more software programs of the central processing unit.

In another embodiment, an electronic system having a panel having a first port and an electronic module located externally to the panel is provided. The electronic module includes a backplane having a second port electrically connected to the first port and an electronic circuit card having a third port electrically connected to the second port. Additionally, the third port is electrically connected to a central processing unit of the electronic circuit card. The first port is connectable to a monitor and control system located externally to the electronic system such that the monitor and control system is electrically connected to the central processing unit for at least one of monitoring and altering the operation of one or more software programs of the central processing unit.

Other embodiments are described and claimed.

### BRIEF DESCRIPTION OF THE DRAWINGS

FIG. 1 illustrates an electronic system according to an embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide a port on an electronic circuit card that is adapted to convey signals between a central processing unit of the electronic circuit card and a monitor and control system for at least one of monitoring and altering operation of one or more software programs of the central processing unit. The port is electrically connectable to the monitor and control system via a backplane of a housing for containing the electronic circuit card and a panel located externally of the housing. This provides an alternative to connecting a monitor and control system directly to ports located on central processing units of electronic circuit cards to monitor and/or alter operation of the software of the central processing units.

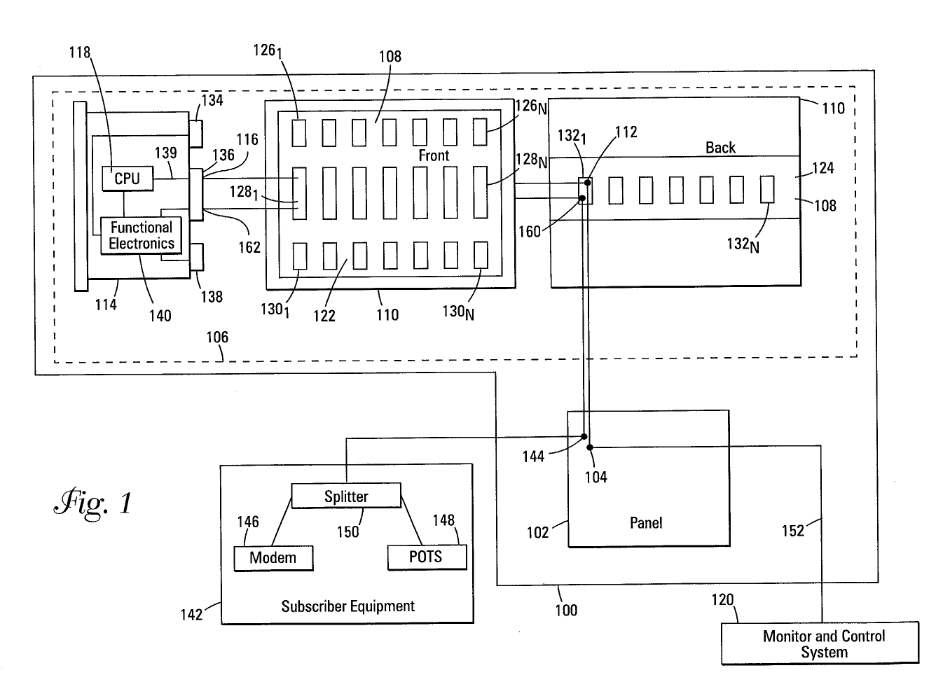

FIG. 1 illustrates an electronic system 100, such as a telecommunications system. Electronic system 100 includes a panel 102 having a port 104. An electronic module 106 is located externally to panel 102. In one embodiment, electronic module 106 is a digital subscriber line (DSL)/voice gateway, such as the MG-1 Multimedia Gateway available from ADC Telecommunications, Eden Prairie, Minn. Electronic module 106 includes a backplane 108 located in a housing 110. Electronic module 106 has a port 112 electrically connected to port 104. An electronic circuit card 114 of electronic module 106 has a port 116 electrically connected to port 112. Port 116 is further electrically connected to a central processing unit 118 of electronic circuit card 114. Port 104 is connectable to a monitor and control system 120, such as a personal computer, an emulation terminal, or the like, located externally to electronic system 100 such that monitor and control system 120 is electrically connected to central processing unit 118 for monitoring and altering the operation of one or more software programs of central processing unit 118. In one embodiment, the one or more software programs of central processing unit 118 control operation of and provide functionality to electronic circuit card 114.

Specifically, backplane 108 has opposing surfaces 122 and 124. In one embodiment, connectors 126₁ to 126_{N}, connectors 128₁ to 128_{N}, and connectors 130₁ to 130_{N} are disposed on surface 122. Connectors 128₁ to 128_{N} are electrically connected to connectors 132₁ to 132_{N} disposed on surface 124, for example by electrically conducting traces disposed within backplane 108. In one embodiment, one of connectors 132, e.g., 132₁, provides port 112. In some embodiments, connectors 132₁ to 132_{N} are 50-pin telco connectors available from Amp, a TYCO International Ltd. Company, Inc., Stoney Creek, Alberta, Canada.

In one embodiment, electronic circuit card 114 includes connectors 134, 136, and 138. Electronic circuit card is inserted into housing 110 so that connectors 134, 136, and 138 respectively mate with one of connectors 126 (e.g., connector 126₁), one of connectors 128 (e.g., connector 128₁), and one of connectors 130 (e.g., connector 130₁). In one embodiment, connector 136 provides port 116. In another embodiment, connector 134 receives DC power from connector 126₁, for example, and supplies the DC power to electronic circuit card 114. In another embodiment, connector 136 conveys voice and/or data signals to and from electronic circuit card 114 via a port 162 of connector 136. In other embodiments, connector 138 is connected to one or more main (or management) electronic circuit cards of electronic module 106 that are connected to backplane 108, e.g., by electrically conducting traces disposed within or on backplane 108.

In various embodiments, electronic module 106 includes several electronic circuit cards 114 each connected to one of connectors 126, one of connectors 128, and one of connectors 130, as shown in FIG. 1 for one of electronic circuit cards 114. In one embodiment, connectors 126 supply power to electronic circuit cards 114. In another embodiment, connectors 128 convey voice and/or data signals to and from electronic circuit cards 114. In yet another embodiment, connectors 130 connect electronic circuit cards 114 to the one or more main electronic circuit cards via electrically conducting traces disposed within or on backplane 108. In other embodiments, connectors 130 connect electronic circuit cards 114 to a UTOPIA bus (Universal Test and Operations Physical Interface Asynchronous Transfer Mode (ATM) bus) of backplane 108 that provides a communications link between electronic circuit cards 114 and the one or more main electronic circuit cards.

Connecting connector 136 to connector 128, electrically connects port 116 to port 112 and thus to port 104 and monitor and control system 120. This provides an alternative to connecting a monitor and control system directly to a port located on central processing unit 118. In various embodiments, central processing unit 118 is electrically connected to port 116 of connector 136 by electrically conducting traces, such as electrically a conducting trace 139 disposed within or on electronic circuit card 114, wires, or the like. Central processing unit 118 is electrically connected to functional electronics 140, e.g., using electrically conducting traces disposed on electronic circuit card 114, or the like. In one embodiment, the one or more software programs of central processing unit 118 communicate with the functional electronics 140 for controlling functional electronics 140 and for receiving information about the operation of functional electronics 140. In various embodiments, electronic circuit card 114 is a line card, such as for providing DSL protocols, e.g., high-bit-rate DSL (HDSL), asymmetric DSL (ADSL), very high-bit-rate DSL (VDSL), single-pair (or G.symmetric) HDSL (G.shdsl), and others. In some embodiments, electronic circuit card 114 is a common telephony module (CTM) card for providing telephony protocols.

To monitor and/or alter the operation of one or more software programs of central processing unit 118 of electronic circuit card 114, monitor and control system 120 is connected to port 104 of panel 102 using a cable 152. In one embodiment, an RS-232 connector connects cable 152 to monitor and control system 120. In some embodiments, to monitor the operation of the one or more software programs of central processing unit 118, informational signals indicative of the operation of the one or more software programs are conveyed from the one or more software programs to port 116 of electronic circuit card 114. The informational signals are conveyed through backplane 108 to port 112 of backplane 108, e.g., from connector 128₁ to 132₁ via traces within the backplane. The informational signals are then conveyed from port 112 to port 104, from where the signals are conveyed to monitor and control system 120. In other embodiments, the informational signals are evaluated at monitor and control system 120. In one embodiment, monitoring the one or more software programs includes monitoring functionality and/or statistics of electronic circuit card 114, e.g., to obtain information about data transfers, line rates, line noise, alarms, etc.

To alter the operation of the one or more software programs of central processing unit 118, in one embodiment, control signals are conveyed to central processing unit 118 by conveying the control signals from monitor and control system 120 to port 104, from port 104 to port 112, through backplane 108 to port 116, and from port 116 to central processing unit 118, where the control signals instruct the one or more software programs of the central processing unit 118 to alter the operation of the one or more software programs. In another embodiment, the control signals are sent in response to the evaluation of the informational signals. In one embodiment, altering the operation of the one or more software programs of central processing unit 118 includes providing inputs for running software codes, downloading new software codes, or the like.

In various embodiments, panel 102 is located in a central office of a telecommunications system. In some embodiments, subscriber equipment 142 is connected to a port 144 of panel 102. Port 144 is also electrically connected to electronic module 106 and communicates with electronic circuit card 114, e.g., via port 160 of connector 1321, backplane 108, and port 162 of connector 136. In other embodiments, subscriber equipment 142 includes a data modem 146 and plane old telephone service (POTS) equipment 148 connected to a splitter 150 that is connected to port 144.

Conclusion

Embodiments of the present invention have been described. The embodiments provide a port on an electronic circuit card that is adapted to convey signals between a central processing unit of the electronic circuit card and a monitor and control system for at least one of monitoring and altering operation of one or more software programs of the central processing unit. The port is electrically connectable to the monitor and control system via a backplane of a housing for containing the electronic circuit card and a panel located externally of the housing. This provides an alternative to connecting a monitor and control system directly to ports located on central processing units of electronic circuit cards to monitor and/or alter operation of the software of the central processing units.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention. It is manifestly intended that this invention be limited only by the following claims and equivalents thereof.

What is claimed is:

1. An electronic circuit card comprising:
a central processing unit;
a port electrically connected to the central processing unit, the port electrically connectable to a monitor and control system via a backplane of a housing for containing the electronic circuit card and a panel located externally of the housing, the monitor and control system located externally of the housing and the panel; and
wherein the port is adapted to convey signals between the central processing unit and the monitor and control system for at least one of monitoring and altering the operation of one or more software programs of the central processing unit.

2. The electronic circuit card of claim 1, further comprising a connector that includes the port and that mates with a connector of the backplane to connect the port to the backplane.

3. The electronic circuit card of claim 1, wherein an electrically conducting trace disposed within or on the electronic circuit card electrically connects the central processing unit to the port.

4. The electronic circuit card of claim 1, further comprising functional electronics electrically connected to the central processing unit.

5. The electronic circuit card of claim 1, further comprising another port electrically connectable to subscriber equipment via the backplane and the panel.

6. An electronic module comprising:
a backplane having a first port;
an electronic circuit card having a second port electrically connected to the first port, the second port further electrically connected to a central processing unit of the electronic circuit card; and
wherein the first port is electrically connectable to a panel located externally to the electronic module so as to electrically connect the central processing unit to a monitor and control system located externally to the panel and the electronic module for at least one of monitoring and altering the operation of one or more software programs of the central processing unit.

7. The electronic module of claim 6, wherein the electronic circuit card comprises a connector that includes the second port and that mates with a connector of the backplane to connect the second port to the first port.

8. The electronic module of claim 6, wherein the electronic circuit card includes a third port electrically connected to a fourth port of the backplane so as to electrically connect the electronic circuit card to subscriber equipment via the panel for conveying voice and data signals between the electronic circuit card and the subscriber equipment.

9. The electronic module of claim 6, wherein the backplane comprises a first connector disposed on a first surface thereof and a second connector on a second surface thereof, the first and second connectors electrically interconnected through the backplane, wherein the first connector includes the first port and the second connector mates with a connector of the electronic circuit card that includes the second port to electrically connect the second port to the first port.

10. The electronic module of claim 6, wherein an electrically conducting trace disposed within or on the electronic circuit card electrically connects the central processing unit to the second port.

11. The electronic module of claim 6, wherein the electronic circuit card comprises functional electronics electrically connected to the central processing unit.

12. An electronic system comprising:
a panel having a first port;
an electronic module located externally to the panel, the electronic module comprising:
a backplane having a second port electrically connected to the first port and
an electronic circuit card having a third port electrically connected to the second port, the third port further electrically connected to a central processing unit of the electronic circuit card; and
wherein the first port is connectable to a monitor and control system located externally to the electronic system such that the monitor and control system is electrically connected to the central processing unit for at least one of monitoring and altering the operation of one or more software programs of the central processing unit.

13. The electronic system of claim 12, wherein the electronic circuit card comprises a connector that includes the third port and that mates with a connector of the backplane to connect the third port to the second port.

14. The electronic system of claim 12, wherein the panel comprises a fourth port electrically connectable to subscriber equipment.

15. The electronic system of claim 12, wherein the electronic circuit card includes fourth port electrically connected to the backplane so as to electrically connect the electronic circuit card to subscriber equipment via the panel for conveying voice and data signals between the electronic circuit card and the subscriber equipment.

16. The electronic system of claim 12, wherein an electrically conducting trace disposed within or on the electronic circuit card electrically connects the central processing unit to the second port.

17. The electronic system of claim 12, wherein the backplane comprises a first connector disposed on a first surface thereof and a second connector on a second surface thereof, the first and second connectors electrically interconnected through the backplane, wherein the first connector includes the second port and the second connector mates with a connector of the electronic circuit card that includes the third port to electrically connect the third port to the second port.

18. The electronic system of claim 12, wherein the electronic circuit card comprises functional electronics electrically connected to the central processing unit.

19. A method for monitoring an electronic circuit card of an electronic module, the method comprising:
transmitting a signal from one or more software programs of a central processing unit of the electronic circuit card to a port of the electronic circuit card, wherein the signal is indicative of operation of the one or more software programs;
conveying the signal from the port of the electronic circuit card to a port of a backplane of the electronic module;
conveying the signal from the port of the backplane to a port on a panel located externally to the electronic module; and
conveying the signal from the port on the panel to a monitor and control system located externally to the electronic module and the panel.

20. A method for altering operation of an electronic circuit card of an electronic module, the method comprising:
transmitting a signal from a monitor and control system to a port of a panel located externally to the monitor and control system and the electronic module;
conveying the signal from the port of the panel to a port of a backplane of the electronic module;
conveying the signal from the port of the backplane to a port of the electronic circuit card;
conveying the signal from the port of the electronic circuit card to a central processing unit of the electronic circuit card; and
instructing one or more software programs of the central processing unit to alter operation of the one or more software programs using the signal.

21. The method of claim 20, wherein transmitting the signal from the monitor and control system to the port of the panel is in response to receiving an informational signal about the operation of the one or more software programs from the central processing unit at the monitor and control system.

22. A method for monitoring and altering operation of an electronic circuit card of an electronic module, the method comprising:
transmitting a signal from one or more software programs of a central processing unit of the electronic circuit card to a port of the electronic circuit card, wherein the signal is indicative of operation of the one or more software programs;
conveying the first signal from the port of the electronic circuit card to a port of a backplane of the electronic module;
conveying the first signal from the port of the backplane to a port on a panel located externally to the electronic module;
conveying the signal from the port on the panel to a monitor and control system located externally to the electronic module and the panel;
evaluating the first signal at the monitor and control system;
transmitting a second signal based on the evaluation of the first signal from the monitor and control system to the port on the panel;
conveying the second signal from the port on the panel to the port of the backplane;
conveying the second signal from the port of the backplane to the port of the electronic circuit card;
conveying the second signal from the port of the electronic circuit card to the central processing unit of the electronic circuit card; and
instructing the one or more software programs of the central processing unit to alter the operation of the one or more software programs using the signal.
